(19) United States
(12) Patent Application Publication
(10) Pub. No.: US 2017/0131707 A1
(43) Pub. Date: May 11, 2017

(54) Fault Symptom Detection System

(71) Applicant: Hitachi, Ltd., Chiyoda-ku Tokyo (JP)

(72) Inventors: Shigetoshi SAKIMURA, Tokyo (JP); Takayuki UCHIDA, Tokyo (JP); Shinya YUDA, Tokyo (JP); Takahiro FUJISHIRO, Tokyo (JP); Kazuyuki TAKADO, Tokyo (JP)

(21) Appl. No.: 15/321,913

(22) PCT Filed: Feb. 12, 2015
(86) PCT No.: PCT/JP2015/053722

§ 371 Date: Dec. 23, 2016

(30) Foreign Application Priority Data
Jun. 27, 2014 (JP) 2014-132027

(51) Int. Cl. G05B 23/02; G06F 11/34

(52) U.S. Cl. CPC G05B 23/0208; G06F 11/3409

(57) ABSTRACT

In the conventional technique, network performances of a machine and a server become different due to the diagnosis target machine when a fault symptom diagnosis function is provided to a plurality of different diagnosis target machines. Therefore, the plurality of different machines are not able to be handled using one system. The present invention is a fault symptom diagnosis system including: a diagnosis execution unit; an arrangement unit; a diagnosis target machine; a diagnosis server; and a network, wherein the diagnosis execution unit includes processing modules of a sensor input processing, a preprocessing, a diagnosis processing, and a postprocessing, and a common interface that connects the processing modules, and wherein the arrangement unit arranges and executes the processing modules in the diagnosis target machine or the diagnosis server.

### TECHNICAL FIELD

The present invention relates to a fault symptom detection technology of a machine. In particular, the invention relates to a fault symptom detection technology of a machine which includes components such as expendable parts and abrasion parts which are necessarily needed to be regularly maintained.

### BACKGROUND ART

Conventionally, “Time-Based Maintenance” has been mainly employed in which the machine is maintained on the basis of a machine operation time. However, “Condition-Based Maintenance” based on a machine operation status is widely employed while a technology of sensing the machine operation status is developed.

PTL 1 is an example of the related art of this technical field. In the related art, there is disclosed a technology in a maintenance field of a conveyance apparatus (in particular, an elevator) in which a monitor device attached to the elevator senses a status of the elevator using an output of a detector (sensor) or a control device and detects a fault symptom in a case where the value exceeds a boundary value in a normal range registered in advance, and a server performs a classification of the fault symptom.

In addition, PTL 2 is disclosed in the related art. In the related art, there is disclosed a technology in which a control processing having no temporal margin is performed in the vehicle, and a diagnosis processing having temporal margin is performed in a diagnosis server when the control of the vehicle and a diagnosis processing are performed in an automobile field.

In these conventional technologies, there are disclosed a configuration that the diagnosis is performed in a diagnosis target machine and a configuration that the diagnosis is performed in a diagnosis server connected to the diagnosis target machine through a network, as a technology related to a status diagnosis and maintenance of the machine.

However, these configurations are separately developed in accordance with a situation of each diagnosis target machine.

Specifically, in a case of an elevator for example, a monitor machine has a wired connection to the server. Therefore, stability in communication can be expected, and a communication speed depends on an installation site (the communication can be made at a highspeed in a city, but may fall in a rural area). Therefore, in a case where the diagnosis target elevator is installed in a city, a diagnosis function may be configured to be executed in the server. However, in the case of a rural area, sensor data sufficient for the diagnosis is not possible to be sent to the server, and thus the diagnosis function is executed in the monitor machine. In addition, for example, since the diagnosis target is a moving body in the case of an automobile, a wireless communication network is assumed. Therefore, the stability in communication is hardly expected. Therefore, the diagnosis function is generally executed in the vehicle (in this case, since the automobile is a daily necessity, a cost restriction is strict on the vehicle components, and thus a high-performance calculation resource is not used. Therefore, a complicated diagnosis algorithm cannot be executed).

In other words, the diagnosis system is separately developed in the related art in accordance with (1) a calculation performance of the diagnosis target machine, (2) a calculation performance of the diagnosis server, and (3) a network performance between the diagnosis target machine and the diagnosis server. More specifically, when the diagnosis system is separately developed, the calculation performance of each of the diagnosis target machine and the server and the communication performance of the network are added with a design margin (stability margin) to set the performance limit. Therefore, the calculation resource for executing the diagnosis function and the network transfer context are statically set in accordance with the performance limit.

### CITATION LIST

### Patent Literature

PTL 1: JP 03288255 B2

PTL 2: JP 2005-529419 A

### SUMMARY OF INVENTION

### Technical Problem

On the other hand, when a service provider of a fault symptom diagnosis function develops the system separately in accordance with the diagnosis target machine, there is a request for developing “a plurality of different diagnosis target machines (and, target business fields of the machine) are covered by one system” because a developing period and a developing cost are separately required. However, as described above, the reason for the separate development is that it is free of physical restrictions such as the calculation performance and the network performance. Therefore, the related art has a problem in that the restrict conditions of the different diagnosis target machines cannot be satisfied using one system.

Furthermore, it is not possible to stably transmit the sensor data to the server in a situation where the communication is unstable. Therefore, there is a problem in that the diagnosis cannot be kept on in a case where the diagnosis is designed to be executed in the server.

Furthermore, the diagnosis function is designed to be statically assigned to any one of the diagnosis target machine and the server in a situation where a sufficient performance in calculation varies (for example, a plurality of diagnosis items are processed in parallel). Therefore, there is a problem in that the diagnosis cannot be kept on when the calculation performance becomes insufficient.

### Solution to Problem

In order to achieve the object, the present invention is a fault symptom diagnosis system including: a diagnosis execution unit; an arrangement unit; a diagnosis target machine; a diagnosis server; and a network, wherein the diagnosis execution unit includes processing modules of a sensor input processing, a preprocessing, a diagnosis processing, and a postprocessing, and a common interface that connects the processing modules, and wherein the arrangement unit arranges and executes the processing modules in the diagnosis target machine or the diagnosis server.

In addition, the present invention is the fault symptom diagnosis system, wherein the arrangement unit includes a load data collection processing, an arrangement destination determination processing, and an arrangement execution processing, and wherein the arrangement unit measures a processing load of each of the diagnosis target machine, the network, and the diagnosis server, and changes an arrangement/execution destination of the processing module to the diagnosis target machine or the diagnosis server according to a variation in the processing load.

In addition, the present invention is the fault symptom diagnosis system, wherein the common interface selects an input unit from among a file input, a memory input, a communication input, and a database input, and selects an output unit from among a file output, a memory output, a communication output, and a database output, and wherein a data conversion unit converts the input data to be matched to the output unit in a case where types of the selected input/output units are different.

In addition, the present invention is the fault symptom diagnosis system, wherein the common interface stores a processing status of the processing module connected to an input of the common interface as a preprocessing status, and wherein the arrangement unit terminates a processing of the processing module which is connected to an output of the common interface in a case where the preprocessing status is not normal.

In addition, the present invention is the fault symptom diagnosis system, wherein the diagnosis target machine or the diagnosis server where the processing module is arranged is displayed in a screen.

In addition, the present invention is the fault symptom diagnosis system, wherein the arrangement unit includes service availability data indicating an arrangement availability of the processing module, and arranges only some of the processing modules in the diagnosis target machine or the diagnosis server using the service availability data.

In addition, the present invention is the fault symptom diagnosis system, wherein the processing module having the same type as that connected to an input of the common interface among the four types of processing modules is connected in series to an output of the common interface.

In addition, the present invention is the fault symptom diagnosis system, wherein the processing modules having the same type among the four types of processing modules are connected in parallel to an output of the common interface.

In addition, the present invention is the fault symptom diagnosis system, wherein dependency definition data is established between the processing modules, and wherein the arrangement unit arranges the processing module to the diagnosis target machine or the diagnosis server to make the arrangement/execution destination of the processing module satisfy the dependency condition.

### Advantageous Effects of Invention

According to the invention, the diagnosis function is divided into the processing modules, a connection interface is made common between the modules, and a plurality of switchable input/output units and data conversion units are provided in a common interface. Therefore, the processing modules can be arranged and executed in any one of a diagnosis target machine and a diagnosis server. Accordingly, the restrict conditions on the different diagnosis target machines can be satisfied using one system.

Specifically, in accordance with a calculation performance of the diagnosis target machine, a communication performance of the network, and a calculation performance of the diagnosis server, a sensor input processing and a preprocessing among the processing modules may be arranged in the diagnosis target machine, and the diagnosis processing and a postprocessing may be arranged in the diagnosis server. As another configuration, only the sensor input processing may be arranged in the diagnosis target machine, and the preprocessing, the diagnosis processing, and the postprocessing may be arranged in the diagnosis server. In this way, a flexible configuration can be made.

In addition, according to the invention, the diagnosis processing can be dynamically changed from the server to the diagnosis target machine according to a communication load situation of the network. Therefore, the sensor data is not transmitted to the server in a situation where the communication is unstable, and the diagnosis can be kept on in the diagnosis target machine.

In addition, according to the invention, an arrangement execution destination can be dynamically changed, in unit of processing module, to the diagnosis server in a case where a load of the diagnosis target machine is large according to a processing load situation of the diagnosis target machine and the diagnosis server, or on the contrary to the diagnosis target machine in a case where a load of the diagnosis server is large. Therefore, the diagnosis can be kept on in any one of the diagnosis target machine and the diagnosis server, where the processing load is low.

### BRIEF DESCRIPTION OF DRAWINGS

FIG. 1 is a diagram illustrating a configuration outline of the invention.

FIG. 2 is a diagram illustrating a configuration of a common interface.

FIG. 3 is a diagram illustrating a processing flow of a load data collection processing.

FIG. 4 is a diagram illustrating an arrangement condition determination rule which is used in an arrangement destination determination processing.

FIG. 5 is a diagram illustrating a processing flow of the arrangement destination determination processing.

FIG. 6 is a diagram illustrating a data structure and a rearrangement example of arrangement data.

FIG. 7 is a diagram illustrating an operation screen example of a fault symptom diagnosis system.

FIG. 8 is a diagram illustrating a data structure and an example of arrangement data in a second embodiment.

FIG. 9 is a diagram illustrating a configuration of a common interface in a third embodiment.

FIG. 10 is a diagram illustrating a configuration of an input switching unit in the third embodiment.

FIG. 11 is a diagram illustrating a configuration of an output switching unit in the third embodiment.

FIG. 12 is a diagram illustrating an exemplary configuration of a diagnosis execution unit in the third embodiment.

FIG. 13 is a diagram illustrating a data structure and an example of arrangement data in a fourth embodiment.

### DESCRIPTION OF EMBODIMENTS

Hereinafter, embodiments will be described using the drawings.

### First Embodiment

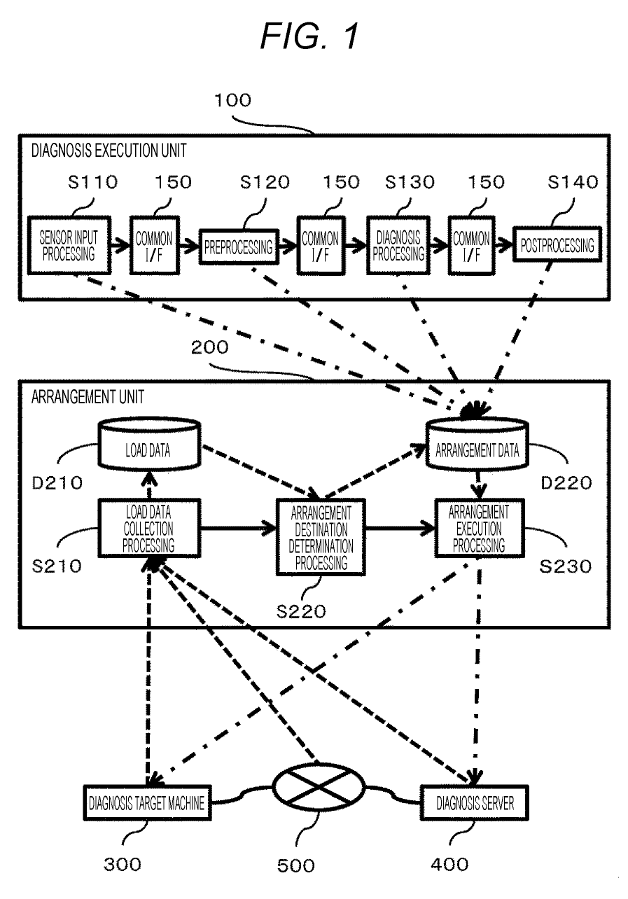

FIG. 1 illustrates a configuration outline of this embodiment. Further, solid arrows in the drawing represent a flow of processing, dotted arrows represent a flow of data, and chain arrows represent an arrangement execution (described below) of processing.

A fault symptom diagnosis system disclosed in the invention is configured by a diagnosis execution unit 100, an arrangement unit 200, a diagnosis target machine 300, a diagnosis server 400, and a network 500. Further, the diagnosis target machine and the diagnosis server in FIG. 1 are provided by one, but each may be configured by multiple units.

Inner processings of the diagnosis execution unit 100 include a sensor input processing S110, a preprocessing S120, a diagnosis processing S130, a postprocessing S140, and a common interface 150 which connects the processings S110 to S140. Further, four processings S110 to S140 will be collectively referred to as a processing module in the invention. A diagnosis function is realized by executing a fault symptom detecting flow which is configured by connecting the processing modules through the common interface. At this time, the procedure returns to the sensor input processing S110 after the postprocessing S140 is ended in order to continuously realize diagnoses of machines.

The sensor input processing S110 uses values of various types of sensors (for example, a physical sensor such as a vibration sensor and a temperature sensor) installed in the diagnosis target machine 300, and a control output value (for example, a motor rotation frequency and an opening level of a valve) of the diagnosis target machine as “operation state information of the machine”. The values used in the processing are unprocessed values of a sensor output value and a control output value, and may contain noises or abnormal values.

The preprocessing S120 performs a data processing in which sensor value data used by the sensor input processing S110 (a processing at the front stage) is processed to be adjusted to the diagnosis processing S130 at the rear stage. For example, there is performed a process of eliminating a value showing an obvious sensor fault such as an ambient temperature of 255° C., or filtering a frequency of the oscillating data.

The diagnosis processing S130 is a fundamental unit of diagnosis, and performs a threshold diagnosis processing for each sensor, and an abnormality diagnosis using a pattern recognition or a discriminator with respect to a sensor vector obtained by binding a plurality of sensor values. For example, in the case of the threshold diagnosis on an assumption that a result of the preprocessing at a point of time T=Ti is set to a three-dimensional vector Si=(Si1, Si2, Si3), thresholds (TH1, TH2, TH3) corresponding to the respective dimensions of the vector are determined, and the number of dimensions exceeding the threshold may be collected for each dimension of the result vector Si of the preprocessing and output as an abnormality rank. In the case of the diagnosis using the discriminator, a result vector of the preprocessing at the time when the machine is normally operated is learned in advance, and the result vector of the preprocessing obtained at the time of diagnosis may be input to the discriminator to obtain the abnormality.

The postprocessing S140 finally determines whether a fault symptom detection system issues a warning on the abnormality of the machine on the basis of the abnormality output by the diagnosis processing S130. For example, the warning is not issued in a case where a high abnormality is shown in the diagnosis processing but a moment, and the warning is issued in a case where a high abnormality is kept for a certain period of time. In this way, a conditional determination is performed.

The respective processing modules forming the diagnosis function are disposed and executed in a calculator resource of the diagnosis target machine or the diagnosis server. At this time, the arrangement unit 200 serves to determine an arrangement/execution destination of each processing module. Further, the processing of the arrangement unit 200 is described to be performed on the diagnosis server 400 in this embodiment, but it is not a restriction of this embodiment. For example, it does not matter if the processing is executed on the diagnosis target machine as long as the diagnosis target machine has sufficient calculation resources.

The arrangement unit 200 is configured by the processing-load data collection processing S210, an arrangement destination determination processing S220, and an arrangement execution processing S230 together with load data D210 and arrangement data D220. Hereinafter, a processing outline will be described.

First, the load data collection processing S210 measures processing loads of the diagnosis target machine 300, the diagnosis server 400, and the network 500, and stores the processing loads in the load data D210. Next, the arrangement destination determination processing S220 determines whether the respective processing modules of S110 to S140 are arranged in the diagnosis target machine or the diagnosis server on the basis of the accumulated load data. The determined content is stored in the arrangement data D220. The details of this processing will be described below. Finally, the arrangement execution processing S230 arranges and executes the respective processing modules in the diagnosis target machine 300 or the diagnosis server 400 on the basis of the arrangement data D220. Further, in arranging of the processing modules, the processing modules may be delivered every time (that is, the arrangement and the execution both are performed every time), or the processing modules may be stored and activated every time in the diagnosis target machine or the diagnosis server in advance (that is, the arrangement is performed in advance, and only the execution is performed every time).

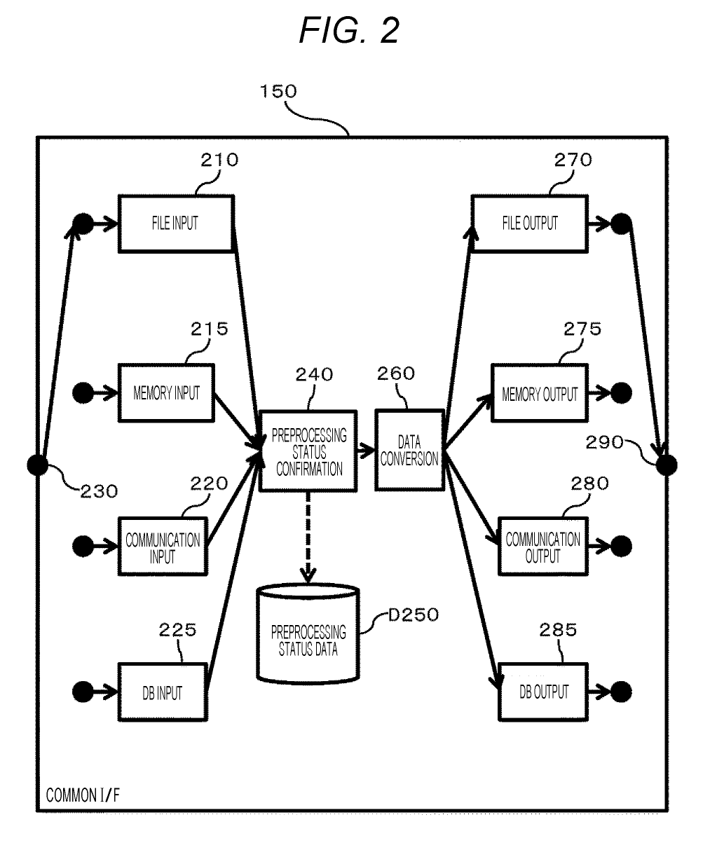

Next, the details of the common interface 150 are illustrated in FIG. 2.

The common interface 150 is configured by an input/output unit in which a file input unit 210, a memory input unit 215, a communication input unit 220, a database (hereinafter, referred to as DB) input unit 225, a file output unit 270, a memory output unit 275, a communication output unit 280, and a DB output unit 285 are paired with by the input and the output, switching units 230 and 290 which switch the input/output unit, a preprocessing status confirmation unit 240, preprocessing status data D250 in which a confirmation result is stored, and a data conversion unit 260.

Hereinafter, the configuration of each portion will be described.

First, the respective input units 210 to 225 receive the output of the processing module (hereinafter, this module will be referred to as a preprocessing module; for example, the preprocessing S120) executed at the front stage of the common interface. At this time, the switching unit 230 acts as a “switch” to select which unit will be used for receiving.

Next, the preprocessing status confirmation unit 240 confirms whether the processings of the processing modules S110 to S140 executed at the front stage of the common interface are normally ended, on the basis of the information obtained through any one of the input units 210 to 225. The confirmation result is stored in the preprocessing status data D250.

Next, the data conversion unit 260 converts the processing result data of the preprocessing module obtained through the input units 210 to 225 as needed. At this time, the necessity of conversion is determined by the following method.
In a case where the conversion is not necessary=a case where an input unit selected in the input unit 210 to 225 is the same as an output unit selected in the output units 270 to 285 (for example, both the input and the output are files).
In a case where the conversion is necessary=a case where the input unit selected in the input unit 210 to 225 is different from the output unit selected in the output units 270 to 285 (for example, the input=file, the output=communication) and, finally the output units 270 to 285 output the processing results of the preprocessing module after the data conversion to the processing module (hereinafter, this module will be referred to as a postprocessing module; for example, the diagnosis processing S130) executed at the rear stage of the common interface. At this time, the switching unit 290 acts as a “switch” to select a unit which will be used for outputting.

Further, four types of data (file, memory, communication, and database) have been described as the input/output unit in this embodiment, but other units may be used. For example, a repository service on the Internet may be used.

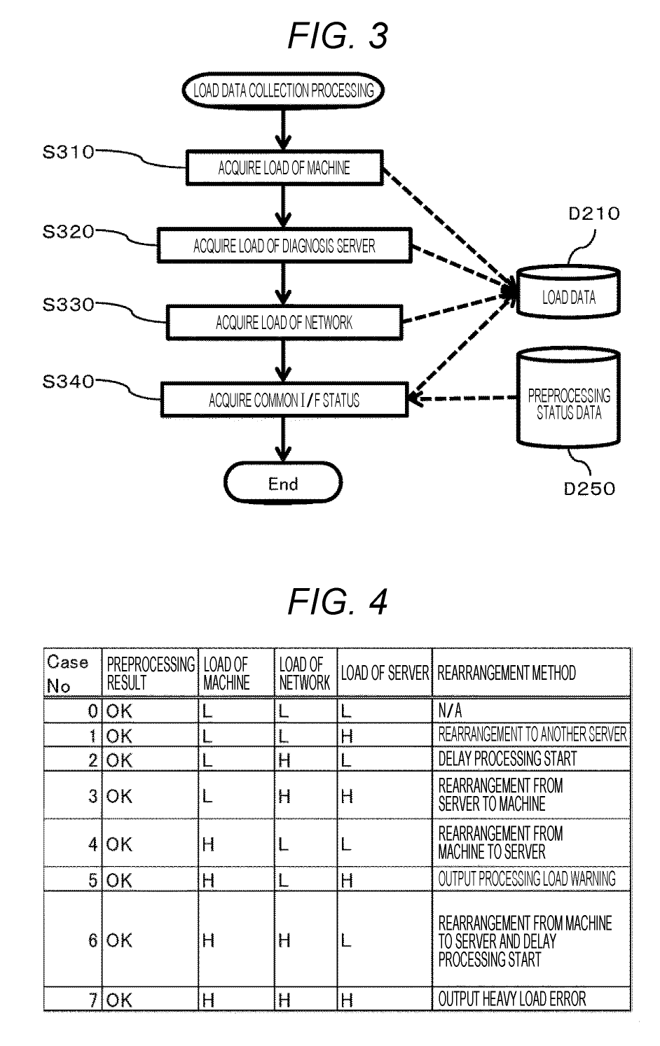

Next, the details of the load data collection processing S210 will be described using FIG. 3.

In the load data collection processing S210, a load of the diagnosis target machine is first acquired, and stored in the load data D210 (S310). For example, a CPU usage rate, a memory usage rate, a power consumption amount, and a remaining battery level of the diagnosis target machine are measured.

Next, a load of the diagnosis server is acquired, and stored in the load data D210 (S320). For example, a CPU usage rate, a memory usage rate, an I/O occupancy rate, and a power consumption amount of the diagnosis server are measured.

Next, a load of the network is acquired, and stored in the load data D210 (S330). For example, a communication availability, a response time, and a communication speed between the diagnosis target machine and the diagnosis server are measured.

Finally, the preprocessing status data D250 of all the common interfaces 150 contained in the diagnosis execution unit 100 is collected, and stored in the load data D210 (S340).

Next, FIG. 4 illustrates an arrangement condition determination rule which is used when an arrangement destination of the processing module is determined by the arrangement destination determination processing S220 described below. Further, “L” in the drawing represents a state of low load, and “H” represents a state of high load.

The arrangement condition determination rule is contained in the arrangement destination determination processing S220, and is determined by discriminating a rearranging method according to a preprocessing status expressed by the load data collected by the load data collection processing S210 and the status.

Hereinafter, the description will be made every Case number.

Case 0 shows a situation in which the preprocessing module is normally ended, and the load also has no problem. Therefore, the rearrangement is not performed.

Case 1 shows a situation in which only the load of the diagnosis server is in a high state. In a case where the postprocessing module is completely arranged on the machine side, the arrangement is particularly not changed. However, in a case where the postprocessing module is completely arranged on the diagnosis server side, the postprocessing module is rearranged in another diagnosis server.

Case 2 shows a situation in which only the load of the network is a high state, there is no problem in the processing loads of both the machine and the diagnosis server, and all the processing results of the preprocessing module completely executed in the machine are not transmitted to the diagnosis server. While the rearrangement of the processing module itself is not performed, a processing start of the postprocessing module completely arranged in the diagnosis server is delayed until the data from the machine is arrived.

Case 3 shows a situation in which the loads of the network and the diagnosis server are in a high state, and the postprocessing is overflowed. Therefore, the postprocessing module is rearranged in the machine, and the processing load is transferred. However, since the calculation resource of the machine is lesser than that of the diagnosis server, the limit of calculation resources of the machine is checked before the rearrangement. If the machine overflows due to the rearrangement, a processing load warning may be issued.

Case 4 shows a situation in which only the load of the machine is in a high state. In a case where the postprocessing module is completely arranged in the diagnosis server, particularly a case where the arrangement is completed in the machine while no change is in there, the postprocessing module is rearranged in the diagnosis server.

Case 5 shows a situation in which both loads of the machine and the diagnosis server are in a high state, and the postprocessing module cannot be shared in either side. Therefore, the processing load warning is issued.

Case 6 shows a situation in which both loads of the machine and the network are in a high state, and there is a need to avoid the processing load from the machine but the network is also tight. The postprocessing module is rearranged from the machine to the diagnosis server, and the processing of the module after the rearrangement is delayed until that the data is arrived from the machine.

Case 7 shows a situation in which all the loads of the machine, the network, and the diagnosis server are in a high state, and the diagnosis cannot be progressed in this situation (even though the diagnosis is progressed, the diagnosis result is not reliable). Therefore, a high load error is issued, and the process is terminated.

Further, in the method of determining a magnitude of the load in this embodiment, the load is compared with a single load rate threshold which is designated in advance, but other methods may be employed. For example, the load rate threshold may be set into two kinds such as an upper threshold and a lower threshold. Then, when the actual load rate exceeds the upper limit, it is determined as a high load, and when being less than the lower threshold, it is determined as a low load. According to this determination method, the load can be determined in a hysteresial manner. In a case where the load rate varies near a single load rate threshold, it is possible to prevent that the determination result is frequently switched.

In addition, the criterion of the arrangement condition determination rule in the invention is not limited to the load of the machine, the load of the network, and the load of the diagnosis server. For example, while the power consumption amount and the remaining battery level are not considered in this embodiment, in a case where the remaining battery level of the machine is low, it maybe applied another rule such that the processing module is rearranged in the diagnosis server similarly to Case 4.

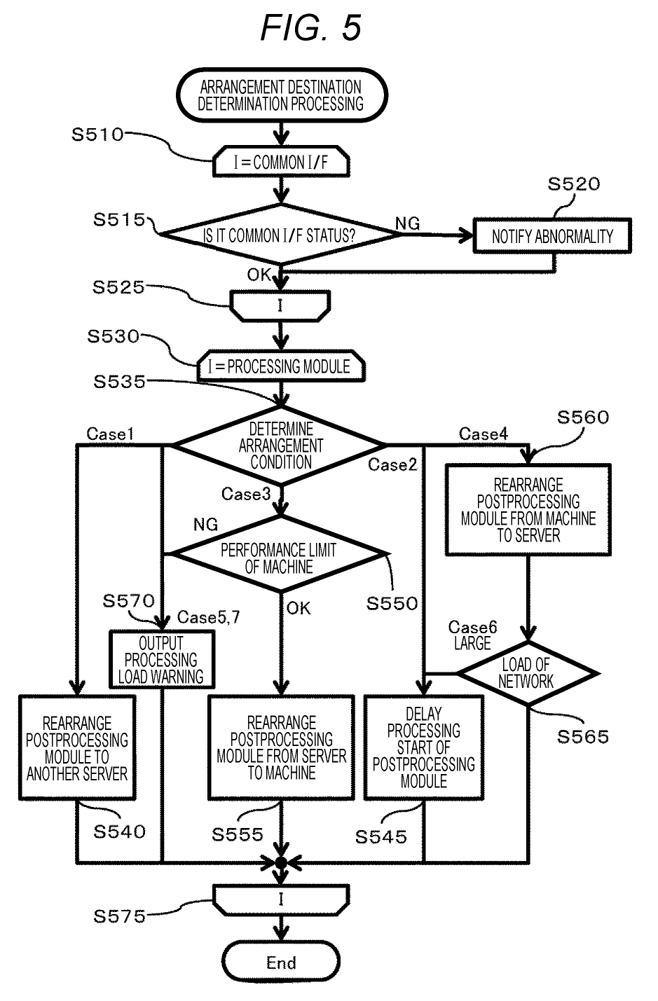

Next, the details of the arrangement destination determination processing S220 will be described using FIG. 5.

In the arrangement destination determination processing S220, it is first determined whether the preprocessing statuses of all the common interfaces included in the diagnosis execution unit 100 are normal (S515). In a case where all the common interfaces are not normal, the abnormality is notified (S520).

Subsequently, all the processing modules included in the diagnosis execution unit 100 are determined about the arrangement condition according to the arrangement condition determination rule described in FIG. 4 (S535), and a processing content is determined according to the determined result. Hereinafter, the description will be made every Case number.

In Case 1, an arrangement destination of the postprocessing module with respect to the common interface during the confirmation of the current status is rearranged from the currently-assigned diagnosis server to another server (S540).

In Case 2, the start of the postprocessing module is delayed while particularly not performing the rearrangement (S545).

In Case 3, a performance limit of the machine is first checked (S550). In a case where the processing does not exceed the performance limit, the postprocessing module is rearranged from the diagnosis server to the machine (S555). In a case where the processing exceeds the limit, the processing load warning is issued (S570).

In Case 4, the postprocessing module is rearranged from the machine to the diagnosis server (S560). Thereafter, the load of the network is checked (S565). In a case where the load is large, the procedure proceeds to Case 6.

In Case 6, the start of the postprocessing module is delayed in addition to the processing in Case 4 (S545).

In Cases 5 and 7, the processing load warning is issued (S570). At this time, the condition of Case 5 or 7 is determined in Step S570. In Case 5, a warning may be issued, and in Case 7, it may be determined as an error.

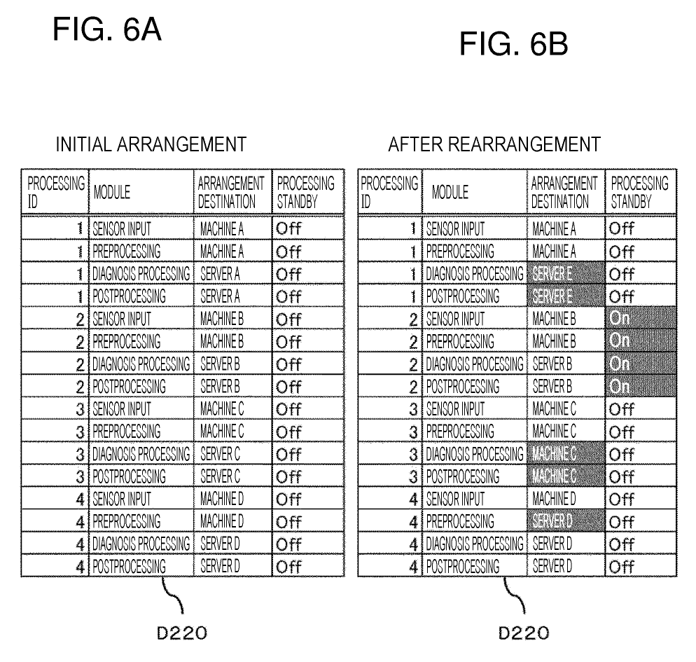

Next, an example of the data format of the arrangement data D220 and the rearrangement of the processing module are illustrated in FIG. 6. Further, FIG. 6(A) shows an example of the arrangement data before the rearrangement (that is, at the time of initial arrangement), and FIG. 6(B) shows an example of the arrangement data after the rearrangement.

In the arrangement data D220, four types of data such as a processing ID, a module name, an arrangement destination, and a processing standby flag are stored.

The processing ID is an ID which is assigned to a diagnosis item of a machine. For example, in a case where there are N diagnosis target machines and M types of diagnosis items (a pump diagnosis, a bearing diagnosis, etc.) per machine, the respective modules of sensor input, preprocessing, diagnosis processing, and postprocessing are performed for each type of diagnosis item. Therefore, the same processing ID is assigned to the processing module in the same set.

The module name represents the type of diagnosis module.

The arrangement destination represents a machine in which each diagnosis module is arranged. Further, when the rearrangement is performed by the arrangement execution processing S230, the processing module is arranged and executed according to the information of the arrangement destination.

The processing standby flag is a flag indicating whether the processing module waits for a processing result of the preprocessing module.

Next, an example of the rearrangement will be described.

First, (A) shows an example in which there are machines A to Das the diagnosis target machines, and the diagnosis items 1 to 4 are assigned to each machine. Furthermore, any of the processing IDs 1 to 4 has an initial arrangement in which two processing modules of the sensor input and the preprocessing are arranged and executed in the machine, and two processing modules of the diagnosis processing and the postprocessing are arranged and executed in the diagnosis server.

Next, a state after the rearrangement obtained as a result of the arrangement destination determination processing S220 is shown in (B). Since the different Cases are exemplified for each processing ID in this example, the description will be made sequentially. Further, highlighted portions in the drawing indicate a changed place.

First, the processing ID 1 corresponds to Case 1 of the arrangement condition determination rule. In this example, the load of the originally-assigned diagnosis server A is increased, and thus the processing module is transferred to another diagnosis server E.

Next, the processing ID 2 corresponds to Case 2. Since there is some margin in both the machine B and the diagnosis server B while the load of the network is high, the processing standby flag is set to “On” to wait for the preprocessing result of the machine B to be input to the diagnosis processing of the diagnosis server B.

Next, the processing ID 3 corresponds to Case 3. Since the load of the diagnosis server C and the load of the network both are high, the diagnosis processing and the postprocessing are also completed in the machine C.

Next, the processing ID 4 corresponds to Case 4. In this example, the load of the machine D is high, so that the processing module is transferred to the diagnosis server D. Since the load of the machine D is sufficiently lowered by transferring only the preprocessing module, the sensor input processing is left in the machine D.

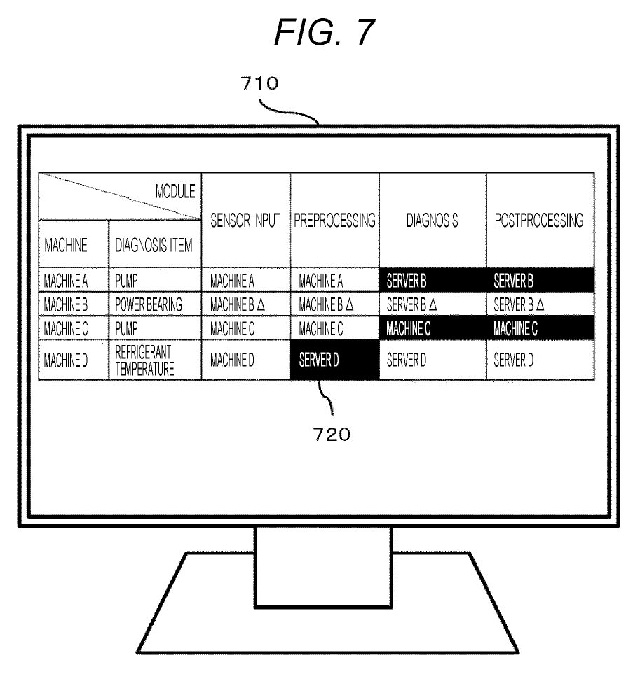

Next, FIG. 7 illustrates an operation screen example of the fault symptom detection system to which the invention is applied.

An operation state list table 720 is displayed in an operation management screen 710.

The items shown in the operation state list table includes a machine name, a diagnosis item, a processing module name, and an arrangement execution destination.

The machine name and the diagnosis item are generated on the basis of assignment data of a general machine ledger which is separately managed, and the processing ID in the arrangement data D220, which indicate “a certain item of a certain machine is diagnosed”.

In the example of FIG. 7, a column of the table represents one diagnosis item, and a row of the table represents the processing module. In addition, the machine name or the diagnosis server name written in the table represents the current arrangement execution destination of each processing module.

Furthermore, in the example of FIG. 7, a portion where the processing module is changed in arrangement is highlighted, and “Δ” is attached at the end of the machine name or the server name where the processing is on standby. However, such a configuration is not a restriction of the invention, and other configurations may be employed as long as the presence/absence of the arrangement change and the presence/absence of the processing standby can be distinguished. For example, icons representing the arrangement change and the processing standby may be used. In addition, a machine changed in arrangement, a machine on standby for the processing, and a normal machine (having no problem) may be separately displayed.

Further, the operation management screen 710 in this embodiment is displayed in any one of the diagnosis servers 400, but the invention is not limited thereto. For example, an operation management server besides the diagnosis server may be installed to display the operation management screen.

### Second Embodiment

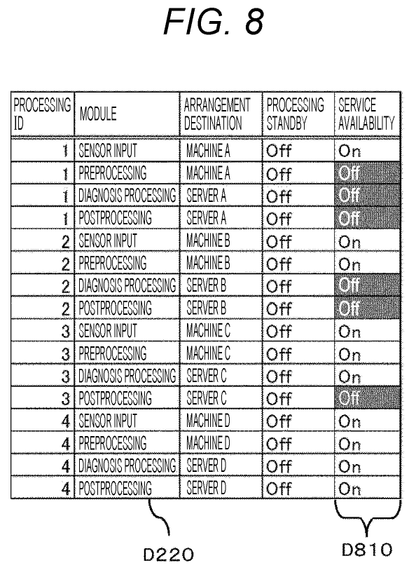

Next, a second embodiment of the invention will be described using FIG. 8.

This embodiment is an example of providing a partial processing flow as well as the configuration of the fault symptom detecting flow containing all the processing modules of the sensor input processing, the preprocessing, the diagnosis processing, and the postprocessing as described in the first embodiment. Further, only configurations of the invention different from those of the first embodiment will be shown, and the same portions will be omitted.

First, the arrangement data D220 in the second embodiment will be described in FIG. 8.

The arrangement data D220 in the second embodiment is added with service availability data D810 in addition to the same item as that of the arrangement data D220 in the first embodiment.

In the service availability data D810, the service availability information of each processing module is stored in advance. Further, in this embodiment, in the case of availability information=On, the service is available, and in the case of availability=Off, the service is unavailable.

In the arrangement execution processing in the first embodiment, the arrangement of the processing modules is executed using only the arrangement destination information in the arrangement data D220. On the contrary, in the arrangement execution processing S230 in the second embodiment, the service availability information is first checked. Then, in a case where the service is available, the arrangement of the processing module is not executed.

Next, the description will be made about a case where the service is set to be unavailable.

In the case of the processing ID 1 in the second embodiment, the arrangement of the processing module after the preprocessing is not executed, and the result of the sensor input processing is provided to the user without any change. Therefore, it is possible to establish a function of monitoring detailed information on a machine operation for a designer of the diagnosis target machine.

In the case of the processing ID 2 in the second embodiment, the arrangement of the processing module after the diagnosis processing is not executed, and the result of the preprocessing is provided to the user. Therefore, it is possible to establish a function of collecting data on a machine operation for an analyst of a diagnosis algorithm.

In the case of the processing ID 3 in the second embodiment, the arrangement of the postprocessing module is not executed, and the result of the diagnosis processing (that is, an abnormality degree output value in every sampling period) is provided to the user. Therefore, it is possible to establish a function of monitoring an abnormality degree trend of the machine.

### Third Embodiment

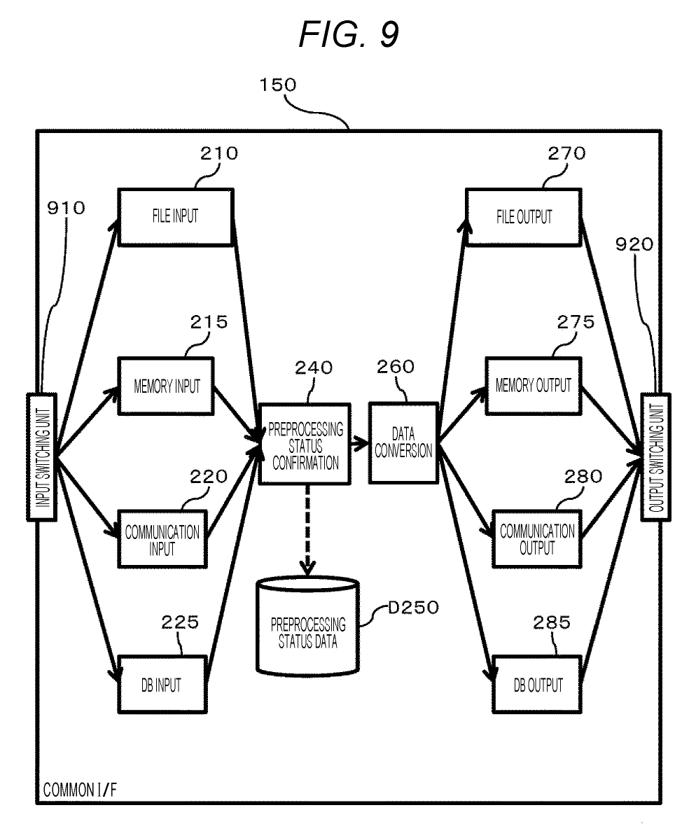

Next, a third embodiment of the invention is illustrated in FIGS. 9 to 12.

This embodiment is an example in which the respective processing modules of the sensor input processing, the preprocessing, the diagnosis processing, and the postprocessing described in the first embodiment are connected in series or in parallel to form a more complicated fault symptom detecting flow. Further, only configurations of the invention different from those of the first embodiment will be shown, and the same portions will be omitted.

First, the common interface 150 in the third embodiment is illustrated in FIG. 9.

A common interface in the third embodiment is different from the common interface of the first embodiment only in the input/output switching unit. Specifically, the input switching unit 230 is replaced with an input switching unit 910, and the output switching unit 290 is replaced with an output switching unit 920.

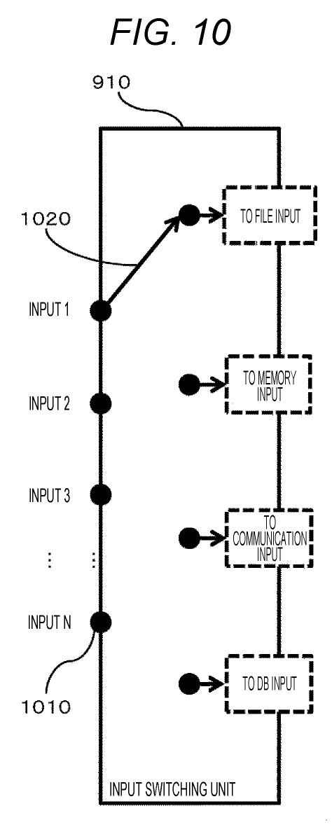

Next, the details of the input switching unit 910 are illustrated in FIG. 10.

The input switching unit 910 is configured by a predetermined number (N) of input terminals 1010 and one switch 1020. The switch selects and connects any one of the input terminals and any one of the file input 210, the memory input 215, the communication input 220, and the DB input 225. Therefore, the input switching unit 910 serves as a “selector” which selects one input from N input and connects the input to one output.

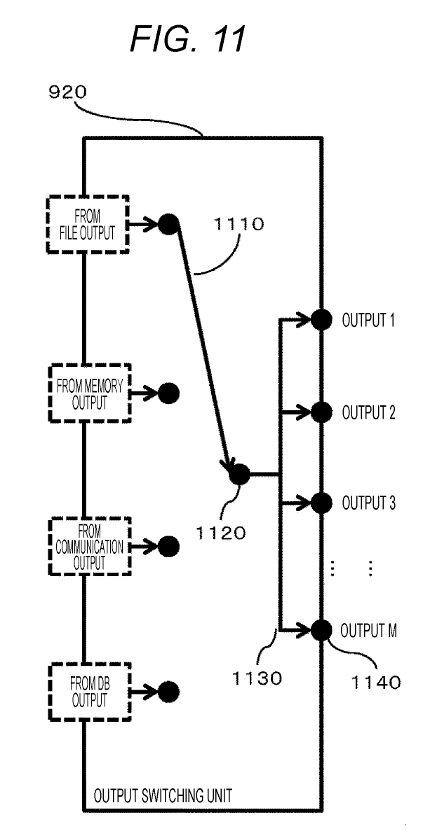

Next, the details of the output switching unit 920 are illustrated in FIG. 11.

The output switching unit 920 is configured by one switch 1110, a relay terminal 1120, a distribution path 1130, and a predetermined number (M) of output terminals 1140. The switch 1110 connects any one of the file output 270, the memory output 275, the communication output 280, and the DB output 285, and the relay terminal in one-to-one manner. In other words, the switch 1110 has a function of selecting the output units 270 to 285. Next, the information flowing through the relay terminal 1120 is output to the output terminal 1140 through the distribution path 1130. Therefore, the output switching unit 920 serves as a “selector/distributor” which selects one input out of four inputs and distributes the input to all the output terminals.

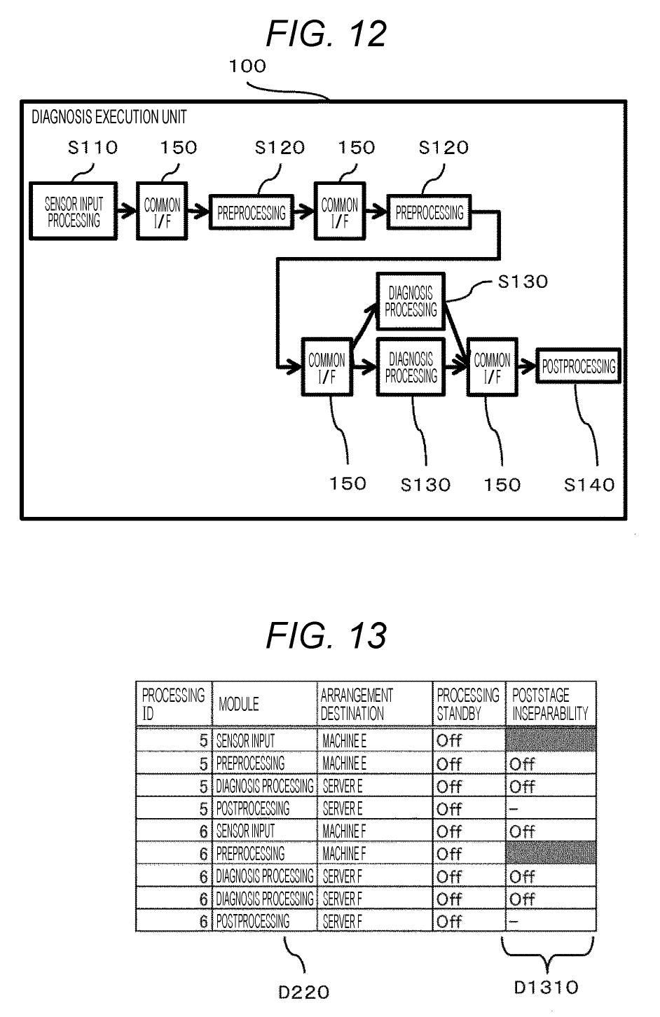

Next, an exemplary configuration of the diagnosis execution unit 100 in the third embodiment is illustrated in FIG. 12.

The diagnosis execution unit 100 in the third embodiment is different from the diagnosis execution unit of the first embodiment in that two preprocessing modules S120 are arranged in series, and two diagnosis processing modules S130 are arranged in parallel. For example, a sensor fault determination and a frequency band filter are connected in series as the preprocessing, and then the double diagnosis algorithm is switched. Since the common interface in the first embodiment is an interface which has one input and one output, such a processing flow is not able to be configured. However, such a configuration can be configured by using the input switching unit 910 and the output switching unit 920 in the third embodiment.

### Fourth Embodiment

Next, a fourth embodiment of the invention is illustrated in FIG. 13.

This embodiment is an example in which, when the arrangement destination is changed, the respective processing modules of the sensor input processing, the preprocessing, the diagnosis processing, and the postprocessing described in the first embodiment are restricted to be arranged in the same calculation resources as those of the arrangement destinations before and after the arrangement. Further, only configurations of the invention different from those of the first embodiment will be shown, and the same portions will be omitted.

First, the arrangement data D220 in the fourth embodiment is illustrated in FIG. 13.

A poststage inseparability flag D1310 is added to the arrangement data D220 in the fourth embodiment in addition to the same items as those of the arrangement data D220 in the first embodiment.

The poststage inseparability flag D1310 stores information therein in advance which indicates whether each processing module can be separately arranged in the calculation resource different from that of the processing module at the poststage of the processing module. In this embodiment, a case of Poststage inseparability flag=On means an inseparability, and a case of Off means a separability.

While the arrangement execution processing in the first embodiment arranges and executes the processing module using only the information of the arrangement destination in the arrangement data D220, the poststage inseparability flag is first check and then the rearrangement of an inseparable processing module is stopped in the arrangement execution processing S230 of the fourth embodiment.

Next, the description will be made about an example in a case where the inseparability is set.

In a case of the processing ID 5 in the fourth embodiment, the poststage processing (that is, the preprocessing) of the sensor input processing is set to be inseparable. Therefore, even if the arrangement execution destination of the preprocessing module is changed by the arrangement destination determination processing S220, the result is cancelled, and the sensor input processing and the preprocessing are arranged and executed on the same machine E.

In a case of the processing ID 6 in the fourth embodiment, the poststage of the preprocessing (that is, the diagnosis processing) is set to be inseparable. Therefore, even if the arrangement execution destination of the diagnosis processing module is changed by the arrangement destination determination processing S220, the result is cancelled, and the preprocessing and the diagnosis processing are arranged and executed on the same machine F.

### REFERENCE SIGNS LIST

100 diagnosis execution unit
200 arrangement unit
300 diagnosis target machine
400 diagnosis server
500 network
S110 sensor input processing
S120 preprocessing
S130 diagnosis processing
S140 postprocessing
150 common interface
S210 load data collection processing
S220 arrangement destination determination processing
S230 arrangement execution processing
D210 load data
D220 arrangement data

1. A fault symptom diagnosis system, comprising:
a diagnosis execution unit;
an arrangement unit;
a diagnosis target machine;
a diagnosis server; and
a network,
wherein the diagnosis execution unit includes
processing modules of a sensor input processing, a preprocessing, a diagnosis processing, and a postprocessing, and
a common interface that connects the processing modules, and
wherein the arrangement unit arranges and executes the processing modules in the diagnosis target machine or the diagnosis server.

2. The fault symptom diagnosis system according to claim 1,
wherein the arrangement unit includes
a load data collection processing,
an arrangement destination determination processing, and
an arrangement execution processing, and
wherein the arrangement unit measures a processing load of each of the diagnosis target machine, the network, and the diagnosis server, and changes an arrangement/execution destination of the processing module to the diagnosis target machine or the diagnosis server according to a variation in the processing load.

3. The fault symptom diagnosis system according to claim 1,
wherein the common interface selects an input unit from among a file input, a memory input, a communication input, and a database input, and selects an output unit from among a file output, a memory output, a communication output, and a database output, and
wherein a data conversion unit converts the input data to be matched to the output unit in a case where types of the selected input/output units are different.

4. The fault symptom diagnosis system according to claim 1,
wherein the common interface stores a processing status of the processing module connected to an input of the common interface as a preprocessing status, and
wherein the arrangement unit terminates a processing of the processing module which is connected to an output of the common interface in a case where the preprocessing status is not normal.

5. The fault symptom diagnosis system according to claim 1, wherein the diagnosis target machine or the diagnosis server where the processing module is arranged is displayed in a screen.

6. The fault symptom diagnosis system according to claim 2,
wherein the arrangement unit includes service availability data indicating an arrangement availability of the processing module, and arranges only some of the processing modules in the diagnosis target machine or the diagnosis server using the service availability data.

7. The fault symptom diagnosis system according to claim 1,
wherein the processing module having the same type as that connected to an input of the common interface among the four types of processing modules is connected in series to an output of the common interface.

8. The fault symptom diagnosis system according to claim 1,
wherein the processing modules having the same type among the four types of processing modules are connected in parallel to an output of the common interface.

9. The fault symptom diagnosis system according to claim 2,
wherein dependency definition data is established between the processing modules, and
wherein the arrangement unit arranges the processing module to the diagnosis target machine or the diagnosis server to make the arrangement/execution destination of the processing module satisfy the dependency condition.
